(19) United States
(12) Patent Application Publication
(10) Pub. No.: US 2026/0253752 A1
(43) Pub. Date: Aug. 27, 2026

(54) Enhanced Bubble Implosion Reactor

(71) Applicant: TMRJ Research LLC, Greer, SC (US)

(72) Inventor: Randy D. Jester, Greer, SC (US)

(21) Appl. No.: 18/071,670

(22) Filed: Nov. 30, 2022

(51) Int. Cl. B01J 3/08; B01J 3/02; B01J 3/06; G21B 1/00

(52) U.S. Cl. CPC G21B 3/00; B01J 3/00; B01J 3/02; B01J 3/062; B01J 2203/0655

(57) ABSTRACT

The volume change of liquid and solid gallium has been studied as a function of pressure and temperature up to 3.02 GPa at 300 K and up to 3.63 GPa at 330 K using synchrotron x-ray microtomography combined with energy dispersive x-ray diffraction techniques. Two sets of directly measured P-V data at 300 K and 330 K were obtained from 3D tomography reconstruction data, and the corresponding isothermal bulk moduli were determined as 23.6 (0.5) GPa and 24.6 (0.4) GPa, respectively. The existence of a liquid-liquid phase transition region is proposed based on the abnormal compressibility of Ga melt at about 2.44 GPa and 330 K conditions.

This work was performed at GSECARS, Sector 13 of APS at Argonne National Laboratory. GSECARS is supported by the National Science Foundation (NSF)-Earth Sciences (EAR-1128799) and Department of Energy (DoE)-GeoSciences (DE-FG02-94ER14466). Y.W. acknowledges NSF grant EAR-1214376 for the development of high-pressure tomography technique. Use of the APS was supported by the U.S. DoE, Office of Science, Office of Basic Energy Sciences, under Contract No. DE-AC02-06CH11357. This work was partially supported by Natural Science Foundation of China (11374075, 10975042), Heilongjiang Province Science Fund for Distinguished Young Scholars (JC201005), Heilongjiang Natural Science Foundation (E200948), Longjiang Scholar, the Fundamental Research Funds for the Central

### Glossary

Cavitation The formation, growth, and collapse of gas and vapor filled bubbles in a liquid. Irradiation of liquids with sound or ultrasound can create acoustic cavitation; turbulent flow of liquids can create hydrodynamic cavitation.
Heterogeneous Sonochemistry The use of high intensity sound or ultrasound to alter chemical reactions in a two phase system, usually a liquid and a solid.
Homogeneous Sonochemistry The use of high intensity sound or ultrasound to alter chemical reactions in a single liquid.
Multi-Bubble Sonoluminescence (MBSL) Emission of light from a cloud of cavitating bubbles formed during ultrasonic irradiation of a liquid.
Single-Bubble Sonoluminescence (SBSL) Emission of light from a single cavitating bubble in a liquid, usually water.
Sonochemistry The use of high intensity sound or ultrasound to alter chemical reactions.
Sonoluminescence Emission of light during ultrasonic irradiation of liquids.

Surprisingly, when liquids are exposed to intense ultrasound, high-energy chemical reactions occur, often with accompanied by the emission of light. Acoustic cavitation is responsible for both sonochemistry and sonoluminescence. Bubble collapse in liquids results in an enormous concentration of energy from the conversion of the kinetic energy of liquid motion into heating of the contents of the bubble. The high local temperatures and pressures, combined with extraordinarily rapid cooling, provide a unique means for driving chemical reactions under extreme conditions. There are three classes of sonochemical reactions: so-called homogeneous sonochemistry of liquids, heterogeneous sonochemistry of liquid-liquid or liquid-solid systems, and sonocatalysis (which overlaps the first two). Sonoluminescence may generally be considered a special case of homogeneous sonochemistry. In some cases, ultrasonic irradiation can increase reactivity by nearly a million-fold. A diverse set of applications of ultrasound to enhance chemical reactivity has been explored, with important applications in mixed phase synthesis, materials chemistry, and biomedical uses. For example, the sonochemical decomposition of volatile organometallic precursors in low-volatility solvents produces nanostructured materials in various forms with high catalytic activities. Nanostructured metals, alloys, carbides and sulfides, nanometer colloids, and nanostructured supported-catalysts can all be prepared by this general route. Another important application of sonochemistry to materials chemistry has been the preparation of biomaterials, most notably protein microspheres. Especially for liquid-solid reactions, the rate enhancements that ultrasound can provide have proved extremely useful for the synthesis of organic and organometallic compounds. Because cavitation can only occur in liquids, chemical reactions are not generally seen in the ultrasonic irradiation of solids or solid-gas systems.

### I. INTRODUCTION TO CAVITATION

When a liquid is irradiated with high intensity sound or ultrasound, acoustic cavitation (the formation, growth, and implosive collapse of bubbles in liquids irradiated with sound) generally occurs. This is the phenomena responsible for sonochemistry and sonoluminescence. During cavitation, the collapse of bubbles produces intense local heating and high pressures, with very short lifetimes. In clouds of cavitating bubbles, these hot-spots have equivalent temperatures of roughly 5000 K, pressures of about 1000 atmospheres, and heating and cooling rates above 10¹⁰ K/s. In single bubble cavitation, conditions may be even more extreme. Cavitation, then, can create extreme physical and chemical conditions in otherwise cold liquids.

If liquids containing solids are irradiated with ultrasound, related phenomena can occur. Near an extended solid surface, cavity collapse becomes non-spherical, which drives high-speed jets of liquid into the solid surface. These jets and associated shock waves can cause substantial surface damage and expose fresh, highly heated surfaces. In addition, high velocity inter-particle collisions will occur during ultrasonic irradiation of liquid-powder suspensions through cavitation and the shockwaves it creates in such slurries. The resultant collisions are capable of inducing dramatic changes in surface morphology, composition, and reactivity.

### A. Acoustic Cavitation

Ultrasound spans the frequencies of roughly 15 kHz to 1 GHz. With typical sound velocities in liquids of ≈1500 m/s, acoustic wavelengths range from roughly 10 to 10⁻⁴ cm. These are not molecular dimensions. Consequently, the chemical effects of ultrasound do not arise from a direct interaction with molecular species: no direct coupling of the acoustic field on a molecular level is responsible for sonochemistry or sonoluminescence. Instead, sonochemistry and sonoluminescence derive principally from acoustic cavitation, which serves as an effective means of concentrating the diffuse energy of sound. Compression of a gas generates heat. When the compression of bubbles occurs during cavitation, it is more rapid than thermal transport and consequently generates a short-lived, localized hot-spot. There is a general consensus that this hot-spot is the source of homogeneous sonochemistry. In 1917, Rayleigh's mathematical model for the collapse of cavities in incompressible liquids predicted enormous local temperatures and pressures. Ten years later, Richards and Loomis reported the first chemical and biological effects of ultrasound.

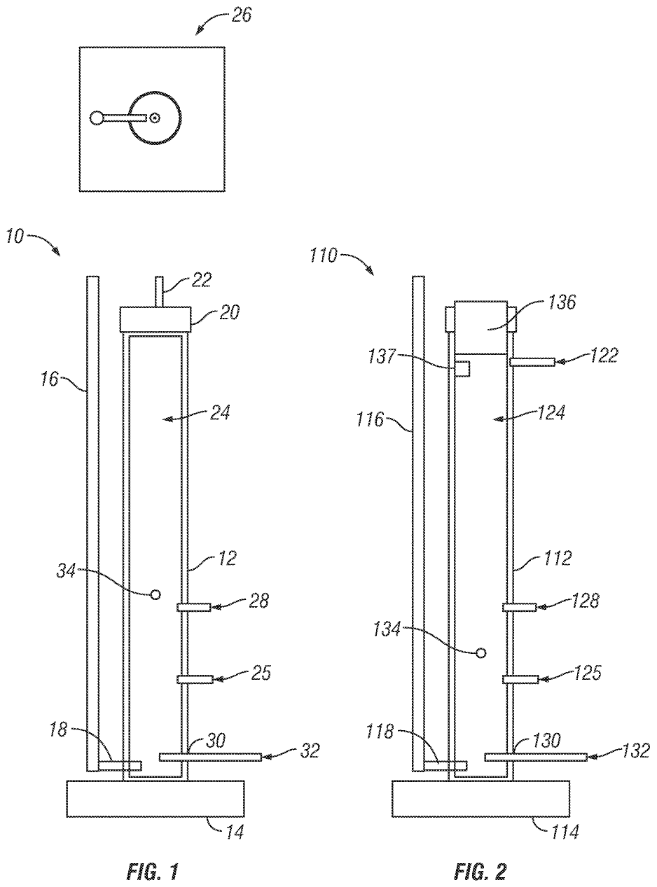

If a moderately intense acoustic field (greater than ≈0.5 MPa) is applied to a liquid, the liquid can fail during the expansion (i.e., tensile or negative pressure) portion of the sound field; weak sites within the liquid (e.g., preexisting gas pockets, called “cavitation nuclei”) are caused to rapidly grow, thereby producing vapor and gas-filled cavities (i.e., bubbles). These bubbles continue to grow during the negative pressure portion of the sound field, until the sound field pressure turns positive. The resulting inertial implosion of the bubbles (now mostly filled with vapor and thus unable to provide stiffness) can be extremely violent, leading to an enormous concentration of energy within the small residual volume of the collapsed bubble (FIG. 1). This violent cavitation event has been termed “transient cavitation.” A normal consequence of this unstable growth and subsequent collapse is that the cavitation bubble itself is destroyed. Gas-filled remnants from the collapse, however, may serve as nucleation sites for subsequent cycles.

For the generally accepted hot-spot theory, the potential energy of the bubble increases as it expands to maximum size, and this energy is then spatially and temporally concentrated into a heated gas core as the bubble implodes. The oscillations of a gas bubble driven by an acoustic field are generally described by “Rayleigh-Plesset” equation; one form of which, called the Gilmore equation, can be expressed a second-order nonlinear differential equation given as

$$R ( 1 - \frac{U}{C} ) \frac{{d}^{2} R}{{dt}^{2}} + \frac{3}{2} ( 1 - \frac{U}{3 C} ) {( \frac{dR}{dt} )}^{2} - ( 1 + \frac{U}{C} ) H - \frac{R}{C} ( 1 - \frac{U}{C} ) \frac{dH}{dt} = 0. \qquad eqn . 1$$

The radius and velocity of the bubble wall are given by R and U respectively. The values for H, the enthalpy at the bubble wall, and C, the local sound speed, may be expressed as follows, using the Tait equation of state for the liquid.

$$H = \frac{n}{n - 1} \frac{{A}^{1 / n}}{{ρ}_{o}} [ {( P ( R ) + B )}^{n - 1 / n} - {( {P}_{∞} ( t ) + B )}^{n - 1 / n} ] \qquad eqn . 2$$

$$and C = [ {c}_{o}^{2} + ( n - 1 ) H ] \qquad eqn . 3$$

The linear speed of sound in the liquid is c₀. A, B, and n are constants which should be set to the appropriate values (for water these values are A=3001 atm., B=A−1, and n=7). The term P_{∞}(t) is the pressure far from the bubble, and includes the ambient pressure plus an appropriate acoustic forcing function. The pressure at the bubble wall (assuming an ideal gas obeying the polytropic law) is given by

$$P ( R ) = ( {P}_{o} + \frac{2 σ}{R} ) {( \frac{{R}_{o}}{R} )}^{3 γ} - \frac{2 σ}{R} - \frac{4 μ U}{R} \qquad eqn . 4$$

where the initial radius of the bubble at time zero is R₀. The ambient pressure of the liquid is P₀, the surface tension σ, the shear viscosity μ, and the polytropic exponent γ.

The validity of the Gilmore equation to compute the behavior of a single, isolated cavitating bubble has been experimentally confirmed. For example, using a light scattering technique, various researchers have obtained measurements of the radius-time curve for single cavitating bubbles (FIG. 2), simultaneous with optical emission from sonoluminescence (see below). The single-bubble sonoluminescent emission is seen as the sharp spike, appearing at the final stages of bubble collapse. Note that these emissions occur at the point of minimum bubble size, and that the general shape of the theoretical radius-time curve is reproduced.

### B. Two-Site Model of Sonochemical Reactivity

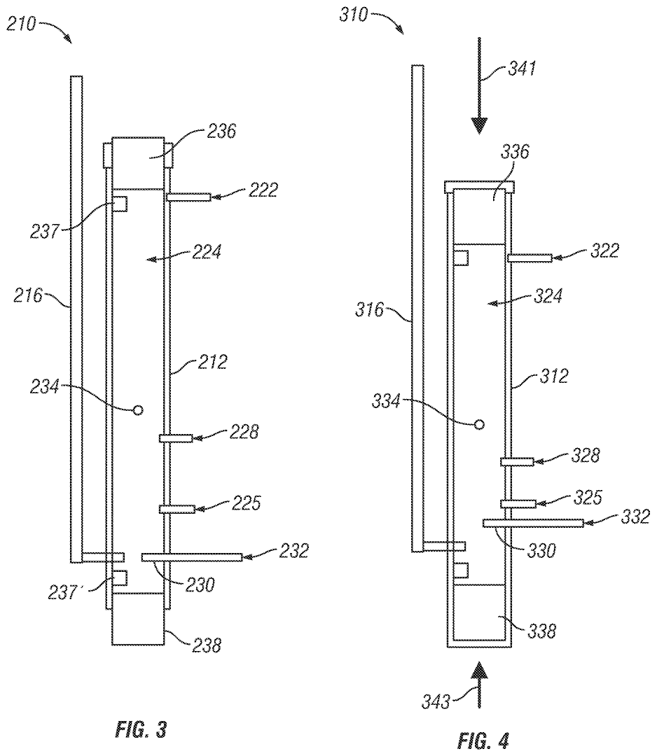

Unfortunately, the complex environment that is present in a cavitation field, in which hundreds or thousands of cavitation bubbles interact during their transient cavitation behavior, precludes conventional measurement of the conditions generated during bubble collapse. Chemical reactions themselves, however, can be used to probe reaction conditions. The effective temperature realized by the collapse of clouds of cavitating bubbles can be determined by the use of competing unimolecular reactions whose rate dependencies on temperature have already been measured. This technique of “comparative-rate chemical thermometry” was used by Suslick, Hammerton, and Cline to first determine the effective temperature reached during cavity collapse. The sonochemical ligand substitutions of volatile metal carbonyls were used as these comparative rate probes. These kinetic studies revealed that there were in fact two sonochemical reaction sites: the first (and dominant site) is the bubble's interior gas-phase while the second is an initially liquid phase. The latter corresponds either to heating of a shell of liquid around the collapsing bubble or to droplets of liquid ejected into the hot-spot by surface wave distortions of the collapsing bubble, as shown schematically in FIG. 3.

In addition, for both sites an effective local temperatures was determined by combining the relative sonochemical reaction rates with the known temperature behavior of these reactions. The effective temperature of these hot-spots was measured at ≈5200 K in the gas-phase reaction zone and ≈1900 K in the initially liquid zone. Of course, the comparative rate data represent only a composite temperature: during the collapse, the temperature has a highly dynamic profile, as well as a spatial temperature gradient. This two-site model has been confirmed with other reactions and alternative measurements of local temperatures by multi-bubble sonoluminescence are consistent, as discussed later.

C. Microjet Formation during Cavitation at Liquid-Solid Interfaces

Very different phenomena occur for cavitation near extended liquid-solid interfaces. There are two mechanisms for the effects of cavitation near surfaces: microjet impact and shockwave damage. Whenever a cavitation bubble is produced near a boundary, the asymmetry of the liquid particle motion during cavity collapse induces a deformation in the cavity. The potential energy of the expanded bubble is converted into kinetic energy of a liquid jet that extends through the bubble's interior and penetrates the opposite bubble wall. Because most of the available energy is transferred to the accelerating jet, rather than the bubble wall itself, this jet can reach velocities of hundreds of meters per second. Because of the induced asymmetry, the jet often impacts the local boundary and can deposit enormous energy densities at the site of impact, especially for larger bubbles (i.e., lower frequency). FIG. 4 shows a photograph of a jet developed in a collapsing cavity. The second mechanism of cavitation-induced surface damage invokes shockwaves created by cavity collapse in the liquid. The impingement of microjets and shockwaves on the surface creates the localized erosion responsible for ultrasonic cleaning and many of the sonochemical effects on heterogeneous reactions. The erosion of metals by cavitation generates newly exposed, highly heated surfaces. Such energy concentration can result in severe damage to the boundary surface; this is less true at higher (MHz) frequencies, simply because the cavitation bubbles are much smaller. This explains the increasing interest in high frequency ultrasonic cleaning for microelectronics (which has been given unfortunate marketing nom-de-guerre of “megasonics”).

In order to induce substantial distortions during bubble collapse, the solid surface must be several times larger than the resonance bubble size: at ≈20 kHz, jet formation becomes important if the solid particles are larger than ≈200 μm. For smaller particles, the shockwaves created by homogeneous cavitation can create high velocity interparticle collisions, as discussed later

### II. SONOLUMINESCENCE

### A. Types of Sonoluminescence

Ultrasonic irradiation of liquids can also produce light, termed “sonoluminescence,” as first observed from water in 1934 by Frenzel and Schultes. As with sonochemistry, sonoluminescence derives from acoustic cavitation. There are two classes of sonoluminescence: multiple-bubble sonoluminescence (MBSL) and single-bubble sonoluminescence (SBSL). Since cavitation is a nucleated process and liquids generally contain large numbers particulates that serve as nuclei, the “cavitation field” generated by a propagating or standing acoustic wave typically consists of very large numbers of interacting bubbles, distributed over an extended region of the liquid. Such cavitation can be sufficiently intense to produce MBSL.

For rather specialized but easily obtainable conditions, it is now established that a single, stable gas bubble can be forced into such large amplitude pulsations that it produces sonoluminescence emissions on each (and every) acoustic cycle. This phenomenon is called single-bubble sonoluminescence (SBSL). Under the appropriate conditions, the acoustic force on a bubble can be used to balance against its buoyancy, holding the bubble stable in the liquid by acoustic levitation. This permits examination of the dynamic characteristics of a single cavitating bubble in considerable detail, from both a theoretical and an experimental perspective. Such a bubble is quite small, compared to an acoustic wavelength (e.g., at 20 kHz, the maximum bubble size before collapse is ~50 μm and at minimum during collapse <1 μm).

### B. Multiple-Bubble Sonoluminescence

The sonoluminescence of aqueous solutions has been studied extensively over the past thirty years. The spectrum of MBSL in water consists of a peak at 310 nm and a broad continuum throughout the visible region. An intensive study of aqueous MBSL was conducted by Verrall and Sehgal and later by Didenko. The emission at 310 nm is from excited-state OH·, but the continuum is difficult to interpret. MBSL from aqueous and alcohol solutions of many metal salts have been reported and are characterized by emission from metal atom excited states.

Flint and Suslick reported the first MBSL spectra of organic liquids. With various hydrocarbons, the observed emission is from excited states of C₂ (d³Π_{g}−a³Πᵤ, the Swan lines), the same emission seen in flames. Furthermore, the ultrasonic irradiation of alkanes in the presence of N₂ (or NH₃ or amines) gives emission from CN excited states, but not from N₂ excited states. Emission from N₂ excited states would have been expected if the MBSL originated from microdischarge, whereas CN emission is typically observed from thermal sources. When oxygen is present, emission from excited states of CO₂, CH·, and OH· is observed, again similar to flame emission.

Ultrasonic irradiation of volatile organometallics (such as Fe(CO)₅ or Cr(CO)₆) in a low volatility organic liquid produces intense sonoluminescence that corresponds to the known atomic emission lines of the metals, again analogous to flame emission. Hot spot temperatures are sufficient not only to dissociate all the CO ligands from the metal complex, but also to produce excited state metal atoms. FIG. 5 shows a typical MBSL spectrum from a metal carbonyl solution (Cr(CO)₆ in this example). Note the intense line emission from the metal atom excited states as well as bands from excited states of the diatomics, C₂ and CH. This metal atom emission provides a useful spectroscopic thermometer, as described below.

For both aqueous and non-aqueous liquids, the emission spectra from MBSL suggests that the principal source of light emission is from chemical reactions involving high-energy species formed during cavitation by bubble collapse. MBSL is principally a form of chemiluminescence, just as flame emission is.

### C. Single-Bubble Sonoluminescence

At the time of this writing, SBSL remains under active investigation with unsettled controversies. Theoretical interpretations of the experimental findings continue to be refined. It is not yet possible to provide a definitive mechanism for the light emission process, although the most favored model involves compressional heating (though probably without a convergent shockwave) of the bubble contents, similar to MBSL. The spectra of MBSL and SBSL, however, show some dramatic differences. While MBSL is generally dominated by atomic and molecular emission lines, SBSL is an essentially featureless emission that increases with decreasing wavelength. For example, an aqueous solution of NaCl shows evidence of excited states of both OH′ and Na in the MBSL spectrum; however, the SBSL spectrum of an identical solution shows no evidence of either of these peaks. Nevertheless, the commonality of cause (acoustic cavitation) and effect (light emission) suggests some association in the underlying physics of sonoluminescence for both MBSL and SBSL.

FIG. 6 illustrates a typical experimental setup for generating SBSL. A piezoelectric, mounted to a water-filled acoustic levitation cell, is driven to set up a standing wave within the water. The drive frequency depends on the size and geometry of the levitation cell (which can be spherical, cylindrical, or even rectangular). The water is typically degassed to about 10% of saturation. A bubble is introduced by injecting air through a syringe into the water. The large bubbles rise to the surface, while the small bubbles are attracted to pressure antinodes. The final size of the remaining bubble at the antinode depends on gas diffusion steady state conditions and instabilities present: if the bubble is too small, gas will transport into the bubble; if the bubble is too large, small microbubbles will be ejected from the main bubble. In this manner, the final bubble comes into a diffusive steady state. Once the bubble is positioned at the pressure antinode, the drive pressure amplitude is increased until sonoluminescence is observed.

The radial motion of the bubble was illustrated in FIG. 2. During the main collapse of the bubble, the interior heats up and at the final stages of collapse, light is emitted. With SBSL, the light emission process may occur each and every acoustic cycle, with a synchronicity better than 1 part per billion; for instance, in a 20 kHz sound field (with a period of 50 μs), the light emission can have a jitter of less than 50 picoseconds.

One intriguing aspect of SBSL is the extremely short duration of the sonoluminescence flash. The measured pulse duration of the light flash has been shown to be below 200 ps, and possibly less than 50 ps in some cases. Due to the low levels of light output from a sonoluminescent bubble, one can not simply use picosecond-response photodiodes. More sophisticated experiments are required. In this case, time-correlated single photon counting is used to measure the pulse duration. Since the experiment measures the time difference between two photons occurring during the same flash, this measurement produces an autocorrelation of the pulse. Due to the complex and transient nature of cavitation fields, one can not employ such averaging techniques to MBSL. The most recent studies of MBSL have shown that for aqueous systems involving air and noble gases, the pulse width is also extremely short, less than 1 ns.

The most plausible explanation for the differences between MBSL and SBSL is simply the degree of compression and the extent of consequent local heating. In SBSL, the bubble collapse is much more spherical than is likely in the complex acoustics of a bubble cloud. As a consequence, the effective temperature reached in single bubble cavitation is probably sufficiently high to induce significant ionization and plasma formation. Under these circumstances, SBSL will be dominated by featureless bremstrahlung emission, rather than bands from atomic or molecular emission as in MBSL.

In keeping with this hypothesis, Suslick and coworkers recently found a series of polar aprotic liquids that can support very strong SBSL, and for the first time, observed line emission from molecular excited states during SBSL. This provides a spectroscopic bridge between SBSL and MBSL and gives direct proof of the existence of chemical reactions and the formation of molecular excited states during single bubble cavitation. In these liquids, both stationary and moving single bubbles could be created. As the sphericity of bubble collapse increases (from MBSL to moving bubble SBSL to stationary bubble SBSL), the efficacy of compression increases, the effective temperatures within the bubble increase, and the emission changes from spectra dominated by excited state molecular emission to featureless (Bremsstrahlung-like) spectra (FIG. 7).

Another major difference between SBSL and MBSL may lie in the contents of the cavitating bubbles. For MBSL, it is generally accepted that a particular bubble in the cavitation field only lasts for a few acoustic cycles before being destroyed, and therefore its contents represent the equilibrium vapor pressures of the solution and its dissolved gases. In contrast, in SBSL, a single bubble can remain stable, emitting light for hours. For air bubbles in water, it is now generally assumed that nitrogen and oxygen molecules dissociate because of the high temperatures, forming NOx compounds that dissolve in the surrounding water, leaving behind only the non-reactive argon inside the bubble. Thus, even though argon represents only a small fraction of the air concentration dissolved in water, the SBSL bubble acts as a chemical reaction chamber that rectifies argon over thousands of acoustic cycles, until the bubble contents are mostly rarefied argon.

### D. Spectroscopic Probes of Cavitation Conditions

Determination of the temperatures reached in cavitating bubbles has remained a difficult experimental problem. As a spectroscopic probe of the cavitation event, MBSL provides a solution. High resolution MBSL spectra from silicone oil under Ar have been reported and analyzed. The observed emission comes from excited states of diatomic carbon (C₂) and has been modeled with synthetic spectra as a function of rotational and vibrational temperatures. From comparison of synthetic to observed spectra, the effective cavitation temperature is 5050±150 K. The excellence of the match between the observed MBSL and the synthetic spectra provides definitive proof that the sonoluminescence event is a thermal, chemiluminescence process. The agreement between this spectroscopic determination of the cavitation temperature and that made by comparative rate thermometry of sonochemical reactions is surprisingly close.

A second spectroscopic thermometer comes from the relative intensities of atomic emission lines in the sonoluminescence spectra of excited state metal atoms produced by sonolysis of volatile Fe, Cr, and Mo carbonyls. Sufficient spectral information about emissivities of many metal atom excited states are available to readily calculate emission spectra as a function of temperature. Because of this, the emission spectra of metal atoms are extensively used by astronomers to monitor the surface temperature of stars. From comparison of calculated spectra and the observed MBSL spectra from metal carbonyls, another measurement of the cavitation temperature can be obtained. The effective emission temperature during cavitation under argon at 20 kHz is 4900±250 K, as shown in the example given in FIG. 8. Again, agreement with prior comparative rate thermometry and the MBSL emission temperature of C₂* excited states is excellent.

One may also able to control the temperature within the cavitation bubble simply by changing the bubble contents. Upon addition of gaseous hydrocarbons (methane, ethylene, or propane), the observed emission temperatures from Cr atom excited states systematically decrease: just 3% propane in Ar, for example, reduces the measured emission temperature to 2500 K. As polyatomic molecules are added to the bubble contents, the polytropic ratio of the gas in the bubble decreases, and so too does the expected temperature from adiabatic compression. The presence of the polyatomic gas simply provides vibrational and rotational modes that will divert much of the kinetic energy of collapse away from a direct temperature increase. The effects of the addition of polyatomic gases on the observed cavitation emission temperature can be quantitatively modeled by simple adiabatic compression of a bubble during cavitational collapse. This simple model predicts pressures on the order of 103 Bar, which is quantitatively consistent with the linewidth broadening and small peak wavelength shifts observed in the metal atom emission. The lifetime of the hot spot is less well determined. Certainly it is under a microsecond and may be considerably less, given the 200 ps emission lifetimes seen in SBSL. The cooling rates, even at us lifetimes, are enormous: above 10¹⁰ K/s.

The interpretation of the spectroscopy of SBSL in water is much less clear. At this writing, SBSL has been observed primarily in aqueous fluids, and the spectra obtained are surprisingly featureless. Some very interesting effects are observed when the gas contents of the bubble are changed. Furthermore, the spectra show practically no evidence of OH emissions, and when He and Ar bubbles are considered, continue to increase in intensity even into the deep ultraviolet. These spectra are reminiscent of black body or bremstrahlung emission with temperatures in excess of 10⁴ K. Several other alternative explanations for SBSL have been presented, and there exists considerable theoretical activity in this particular aspect of SBSL.

### II. SONOCHEMISTRY

In a fundamental sense, chemistry is the interaction of energy and matter. Chemical reactions require energy in one form or another to proceed: chemistry stops as the temperature approaches absolute zero. One has only limited control, however, over the nature of this interaction. In large part, the properties of a specific energy source determines the course of a chemical reaction. Ultrasonic irradiation differs from traditional energy sources (such as heat, light, or ionizing radiation) in duration, pressure, and energy per molecule. The immense local temperatures and pressures and the extraordinary heating and cooling rates generated by cavitation bubble collapse mean that ultrasound provides an unusual mechanism for generating high energy chemistry. Like photochemistry, very large amounts of energy are introduced in a short period of time, but it is thermal, not electronic, excitation. As in flash pyrolysis, high thermal temperatures are reached, but the duration is very much shorter (by >10⁴) and the temperatures are even higher (by five- to ten-fold). Similar to shock-tube chemistry or multiphoton infrared laser photolysis, cavitation heating is very short lived, but occurs within condensed phases. Furthermore, sonochemistry has a high-pressure component, which suggests that one might be able to produce on a microscopic scale the same macroscopic conditions of high temperature-pressure “bomb” reactions or explosive shockwave synthesis in solids. FIG. 9 presents an interesting comparison of the parameters that control chemical reactivity (time, pressure, and energy) for various forms of chemistry.

The same limitations apply to the control of sonochemical reactions as in any thermal process: the Boltzmann energy distribution means that the energy per individual molecule will vary widely. One does have easy control, however, over the intensity of heating generated by acoustic cavitation using various physical parameters. The origin of these influences is easily understood in terms of the hot-spot mechanism of sonochemistry. The most important parameters are thermal conductivity of dissolved gases (which can effect the degree of adiabaticity), polyatomic content inside the bubble (which reduces compressional heating), and acoustic pressure. As acoustic pressure is increased, there is a threshold value for nucleation and bubble growth and hence sonochemistry, followed by an increase in sonochemical rates due to increased numbers of effectively cavitating bubbles. At sufficiently high intensities, the cavitation of the liquid near the radiating surface becomes so intense as to produce a shroud of bubbles, diminishing penetration of sound into the liquid and decreasing sonochemical rates. In contrast, frequency appears to be less important, at least within the range where cavitation can occur (a few hertz to a few megahertz), although there have been few detailed studies of its role.

Homogeneous sonochemistry typically is not a very energy efficient process, whereas heterogeneous sonochemistry is several orders of magnitude better. Since ultrasound can be produced with nearly perfect efficiency from electric power, the primary energy inefficiency is due to the small fraction of the acoustic power actually involved in the cavitation events. This might be significantly improved, however, if a more efficient means of coupling the sound field to generate cavitation can be found.

### A. Experimental Design

A variety of devices have been used for ultrasonic irradiation of solutions. There are three general designs in use presently: the ultrasonic cleaning bath, the direct immersion ultrasonic horn, and flow reactors. The originating source of the ultrasound is generally a piezoelectric material, usually a lead zirconate titanate ceramic (PZT), which is subjected to a high AC voltage with an ultrasonic frequency (typically 15 to 50 kHz). For industrial use, the more robust magnetostrictive metal alloys (usually of Ni) can be used as the core of a solenoid generating an alternating magnetic field with an ultrasonic frequency. The vibrating source is attached to the wall of a cleaning bath, to an amplifying horn, or to the outer surfaces of a flow-through tube or diaphragm.

The ultrasonic cleaning bath is clearly the most accessible source of laboratory ultrasound and has been used successfully for a variety of liquid-solid heterogeneous sonochemical studies. The low intensity available in these devices (≈1 W/cm²), however, means that even in the case of heterogeneous sonochemistry, an ultrasonic cleaning bath must be viewed as an apparatus of limited capability. The most intense and reliable source of ultrasound generally used in the chemical laboratory is the direct immersion ultrasonic horn (50 to 500 W/cm²), as shown in FIG. 10, which can be used for work under either inert or reactive atmospheres or at moderate pressures (<10 atmospheres). These devices are available from several manufacturers at modest cost. Commercially available flowthrough reaction chambers that will attach to these horns allow the processing of multi-liter volumes. The acoustic intensities are easily and reproducibly variable; the acoustic frequency is well controlled, albeit fixed (typically at 20 kHz). Since power levels are quite high, counter-cooling of the reaction solution is essential to provide temperature control. Large-scale ultrasonic generation in flow-trough configurations is a well-established technology. Liquid processing rates of 200 L/min are routinely accessible from a variety of modular, in-line designs with acoustic power of ≈20 kW per unit. The industrial uses of these units include 1) degassing of liquids, 2) dispersion of solids into liquids, 3) emulsification of immiscible liquids and 4) large-scale cell disruption.

### B. Homogeneous Sonochemistry: Bond Breaking and Radical Formation

The chemical effect of ultrasound on aqueous solutions have been studied for many years. The primary products are H₂ and H₂O₂; there is strong evidence for various high-energy intermediates, including HO₂, H·, OH·, and perhaps e⁻_{(aq)}. The work of Riesz and collaborators used electron paramagnetic resonance with chemical spin-traps to demonstrate definitively the generation of H· and OH· during ultrasonic irradiation, even with clinical sources of ultrasound. The extensive work in Henglein's laboratory involving aqueous sonochemistry of dissolved gases has established clear analogies to combustion processes. As one would expect, the sonolysis of water, which produces both strong reductants and oxidants, is capable of causing secondary oxidation and reduction reactions, as often observed. Most recently there has been strong interest shown in the use of ultrasound for remediation of low levels of organic contamination of water The OH· radicals produced from the sonolysis of water are able to attack essentially all organic compounds (including halocarbons, pesticides, and nitroaromatics) and through a series of reactions oxidize them fully. The desirability of sonolysis for such remediation lies in its low maintenance requirements and the low energy efficiency of alternative methods (e.g., ozonolysis, UV photolysis).

In contrast, the ultrasonic irradiation of organic liquids has been less studied. Suslick and coworkers established that virtually all organic liquids will generate free radicals upon ultrasonic irradiation, as long as the total vapor pressure is low enough to allow effective bubble collapse. The sonolysis of simple hydrocarbons (for example, n-alkanes) creates the same kinds of products associated with very high temperature pyrolysis. Most of these products (H₂, CH₄, and the smaller 1-alkenes) derive from a well-understood radical chain mechanism.

The sonochemistry of solutes dissolved in organic liquids also remains largely unexplored. The sonochemistry of metal carbonyl compounds is an exception. Detailed studies of these systems led to important mechanistic understandings of the nature of sonochemistry. A variety of unusual reactivity patterns have been observed during ultrasonic irradiation, including multiple ligand dissociation, novel metal cluster formation, and the initiation of homogeneous catalysis at low ambient temperature.

### C. Applications of Sonochemistry to Materials Synthesis and Catalysis

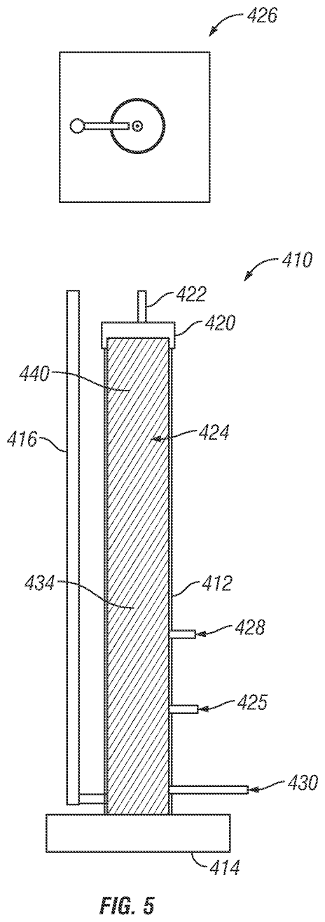

Of special interest is the recent development of sonochemistry as a synthetic tool for the creation of unusual inorganic materials. As one example, the recent discovery of a simple sonochemical synthesis of amorphous iron helped settle the longstanding controversy over its magnetic properties More generally, ultrasound has proved extremely useful in the synthesis of a wide range of nanostructured materials, including high surface area transition metals, alloys, carbides, oxides and colloids Sonochemical decomposition of volatile organometallic precursors in high boiling solvents produces nanostructured materials in various forms with high catalytic activities. Nanometer colloids, nanoporous high surface area aggregates, and nanostructured oxide supported catalysts can all be prepared by this general route, as shown schematically in FIG. 11. There remains much to explore in the sonochemical synthesis of inorganic materials, and this technique has only begun to be exploited.

Heterogeneous catalysis is extremely important in the chemical and petroleum industries, and the applications of ultrasound to catalysis have been reviewed recently. The effects of ultrasound on catalysis can occur in three distinct stages: (i) during the formation of supported catalysts, (ii) activation of pre-formed catalysts, or (iii) enhancement of catalytic behavior during a catalytic reaction. In the cases of modest rate increases, it appears likely that the cause is increased effective surface area; this is especially important in the case of catalysts supported on brittle solids. More impressive accelerations, however, have included hydrogenations and hydrosilations by Ni powder, Raney Ni, and Pd or Pt on carbon. For example, the hydrogenation of alkenes by Ni powder is enormously enhanced (>10⁵-fold) by ultrasonic irradiation. As discussed in the next section, this dramatic increase in catalytic activity is due to the formation of uncontaminated metal surfaces from interparticle collisions caused by cavitation-induced shockwaves.

Heterogeneous catalysts often require rare and expensive metals. The use of ultrasound offers some hope of activating less reactive, but also less costly, metals. As one example, ultrasonic irradiation of solutions of Mo(CO)₆ produces aggregates of nanometer-sized clusters of face centered cubic molybdenum carbide. The material was extremely porous with a high surface area and consisted of aggregates of ≈2 nm sized particles. The catalytic properties showed the molybdenum carbide generated by ultrasound is an active and highly selective dehydrogenation catalyst comparable to commercial ultrafine platinum powder.

The sonochemical synthesis of nanostructured molybdenum sulfide provides another example of the utility of sonochemistry to the production of active catalysts. MoS₂ is best known as a standard automotive lubricant; its lubricant properties are due to its layered structure. Planes of molybdenum atoms are sandwiched on both faces by planes of sulfur atoms tightly bonded to the Mo. Interactions between the sulfur planes are weak, thus producing lubrication properties similar to graphite. Of greater interest here, however, MoS₂ is also the predominant hydrodesulfurization catalyst heavily used by the petroleum industry to remove sulfur from fossil fuels before combustion. Sonochemistry provides an unusual morphology of MoS₂ by the irradiation of solutions of molybdenum hexacarbonyl, as shown in FIG. 12. Conventional MoS₂ shows a plate-like morphology typical for such layered materials. The sonochemical MoS₂ exists as a porous agglomeration of clusters of spherical particles with an average diameter of 15 nm. Despite the morphological difference between the sonochemical and conventional MoS₂, TEM images of both sulfides show lattice fringes with interlayer spacings of 0.62±0.01 nm. The sonochemically prepared MoS₂, however, shows much greater edge and defect content, as the layers must bend, break or otherwise distort to form the outer surface of the 15 nm particle size. It is well established that the activity of MoS₂ is localized at the edges and not on the flat basal planes Given the inherently higher edge concentrations in nanostructured materials, the catalytic properties of sonochemically prepared shows substantially increased activity for hydrodesulfurization, comparable to those observed with RuS₂, one of the best prior catalysts.

Sonochemistry is also proving to have important applications with polymeric materials. Substantial work has been accomplished in the sonochemical initiation of polymerization and in the modification of polymers after synthesis. The use of sonolysis to create radicals which function as radical initiators has been well explored. Similarly the use of sonochemically prepared radicals and other reactive species to modify the surface properties of polymers is being developed, particularly by G. Price. Other effects of ultrasound on long chain polymers tend to be mechanical cleavage, which produces relatively uniform size distributions of shorter chain lengths.

Another important application has been the sonochemical preparation of biomaterials, most notably protein microspheres. Using high intensity ultrasound and simple protein solutions, a remarkably easy method to make both air-filled microbubbles and nonaqueous liquid-filled microcapsules has been developed. As shown in FIG. 13, These protein microspheres have a wide range of biomedical applications, including their use as echo contrast agents for sonography, magnetic resonance imaging contrast enhancement, drug delivery, among others, and have generated a substantial patent estate. The microspheres are stable for months, and being slightly smaller than erythrocytes, can be intravenously injected to pass unimpeded through the circulatory system. The mechanism responsible for microsphere formation is a combination of two acoustic phenomena: emulsification and cavitation. Ultrasonic emulsification creates the microscopic dispersion of the protein solution necessary to form the proteinaceous microspheres. The long life of these microspheres comes from a sonochemical cross-linking of the protein shell. Protein cysteine residues are oxidized during microsphere formation by sonochemically produced superoxide.

D. Heterogeneous Sonochemistry: Reactions of Solids with Liquids

The use of ultrasound to accelerate chemical reactions in heterogeneous systems has become increasingly widespread. The physical phenomena that are responsible include the creation of emulsions at liquid-liquid interfaces, the generation of cavitational erosion and cleaning at liquid-solid interfaces, the production of shock wave damage and deformation of solid surfaces, the enhancement in surface area from fragmentation of friable solids, and the improvement of mass transport from turbulent mixing and acoustic streaming.

Suslick and coworkers have found that the turbulent flow and shockwaves produced by intense ultrasound can drive metal particles together at sufficiently high speeds to induce effective melting in direct collisions (FIG. 14) and the abrasion of surface crystallites in glancing impacts (FIG. 15). A series of transition metal powders were used to probe the maximum temperatures and speeds reached during interparticle collisions. Using the irradiation of Cr, Mo, and W powders in decane at 20 kHz and 50 W/cm², agglomeration and essentially a localized melting occurs for the first two metals, but not the third. On the basis of the melting points of these metals, the effective transient temperature reached at the point of impact during interparticle collisions is roughly 3000° C. (which is unrelated to the temperature inside the hot-spot of a collapsing bubble). From the volume of the melted region of impact, the amount of energy generated during collision was determined. From this, a lower estimate of the velocity of impact is roughly one half the speed of sound, in agreement with expected particle velocities from cavitation-induced shockwaves in the liquid.

To enhance the reactivity of reactive metals as stoichiometric reagents, ultrasonic irradiation has become an especially routine synthetic technique for many heterogeneous organic and organometallic reactions particularly those involving reactive metals, such as Mg, Li or Zn. This development originated from the early work of Renaud and the more recent breakthroughs of Luche and others. Examples are shown in equations 5 through 7, where R represents an organic functional group and ))) represents ultrasonic irradiation. The effects are quite general and apply to reactive inorganic salts and to main group reagents as well. Less work has been done with unreactive metals (e.g., V, Nb, Mo, W), but results here are promising as well. Rate enhancements of more than tenfold are common, yields are often substantially improved, and byproducts avoided.

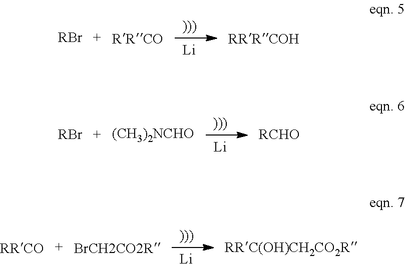

The mechanism of the sonochemical rate enhancements in both stoichiometric and catalytic reactions of metals is associated with dramatic changes in morphology of both large extended surfaces and of powders. As discussed earlier, these changes originate from microjet impact on large surfaces and high-velocity interparticle collisions in slurries. Surface composition studies by Auger electron spectroscopy and sputtered neutral mass spectrometry reveal that ultrasonic irradiation effectively removes surface oxide and other contaminating coatings. The removal of such passivating coatings can dramatically improve reaction rates. The reactivity of clean metal surfaces also appears to be responsible for the greater tendency for heterogeneous sonochemical reactions to involve single electron transfer rather than acid-base chemistry.

Applications of ultrasound to electrochemistry have also seen substantial recent progress. Beneficial effects of ultrasound on electroplating and on organic synthetic applications of organic electrochemistry have been known for quite some time. More recent studies have focused on the underlying physical theory of enhanced mass transport near electrode surfaces Another important application for sonoelectrochemistry has been developed by J. Reisse and coworkers for the electroreductive synthesis of sub-micrometer powders of transition metals.

### III. SUMMARY

The phenomenon of acoustic cavitation results in an enormous concentration of energy. The enormous local temperatures and pressures so created result in both sonochemistry and sonoluminescence, which provide a unique means for fundamental studies of chemistry and physics under extreme conditions. The chemical consequences of acoustic cavitation are far reaching, both in homogeneous liquids and in mixed-phase system. In the latter, cavitation can have dramatic effects on the reactivities of both extended solid surfaces and on fine powder slurries through microjet and shock wave impact (on large surfaces) and interparticle collisions (with powders). The applications of sonochemistry are diverse and still emerging, especially in the areas of mixed phase synthesis, materials chemistry, and biomedical products.

1. A method of generating a gas bubble implosion comprising:
(a) providing a rigid structural container, completely filled with a liquid metal and sealed, wherein the rigid structural container is made of a material substantially inert with respect to the liquid metal and has an injection port for introduction of a small controlled 0.1 to 10 mm diameter gas bubble of controlled composition;
(b) introducing said 0.1 to 10 mm diameter gas bubble of controlled composition to float suspended in the liquid metal in the rigid structural container;
(c) subjecting said container containing the liquid metal and the introduced gas bubble to an external shock produced by dropping, mechanical pistons or magnetic pulse whereby the internal bubble is collapsed by the liquid shockwave producing high internal bubble pressure and temperature.

2. The method of claim 1 where the liquid metal is a metal at a temperature above its melting point.

3. The method of claim 1 where the liquid metal is mercury (Hg).

4. The method of claim 1 where the liquid metal is a liquid gallium alloy.

5. The method of claim 1 where the rigid structural container is pressurized to further increase the collapsing gas bubble internal pressure.

6. The method of claim 1 where the introduced gas is a reactive gas or mixture of reactive gasses, said reactive gas or reactive gasses being reactive under conditions of temperature and pressure in the collapsing gas bubble.

7. The method of claim 1 where the introduced gas is hydrogen, deuterium, tritium or a mixture of one or more of these isotopes.

8. The method of claim 1 where the introduced gas is methane.

9. The method of claim 1 where the rigid structural container is made of steel, iron, aluminum coated with Al₂O₃ or glass, filled with mercury, and has a gas introduction syringe at the bottom of the container where the 0.1 to 10 mm diameter bubble of a defined gas is introduced, allowed to float to a suspended position and the cylinder is dropped vertically onto a solid base thereof to generate a hydraulic shockwave impacting the suspended bubble.

10. The method of claim 1 where the rigid structural container is provided with a top including a tight fitting piston, filled with mercury, provided with a gas introduction syringe at the bottom, wherein a bubble of a defined gas is introduced, allowed to float to a suspended position and impacted with the piston mechanically to generate a hydraulic shockwave which impacts the suspended bubble.

11. The method of claim 1 where the rigid structural container is provided with tight fitting pistons on two or more opposing sides, the container is filled with mercury, and has a gas introduction syringe introducing a bubble of a defined gas, allowing the bubble to float to a suspended position and impacting the pistons simultaneously so as to mechanically to generate a hydraulic shockwave impacting the suspended bubble.

12. The method of claim 1 where the rigid structural container is provided with internal pistons produced from a strong neodymium type permanent magnet that are pulsed by an external opposing magnetic force to generate the shockwave and ameliorate sealing issues.

13. The method of claim 1 wherein the container is made from a nonmagnetic material and the shockwave is produced by a magnetic pulse acting on the mercury.

14. An apparatus for generating a gas bubble implosion comprising:
(a) a rigid structural container, completely filled with a liquid metal and sealed, wherein the rigid structural container is made of a material substantially inert with respect to the liquid metal and has an injection port for introduction of a small controlled 0.1 to 10 mm diameter gas bubble of controlled composition in the liquid metal;
(b) a gas feeder introducing said 0.1 to 10 mm diameter gas bubble of controlled composition to float suspended as an internal bubble in the liquid metal in the rigid structural container;
(c) wherein the rigid structural container is constructed and arranged to provide an external shock produced by dropping, or is provided with one or more mechanical pistons operative provide an external shock or is wired and configured to provide an external shock by way of a magnetic pulse whereby the internal bubble is collapsed by the liquid shockwave producing high internal bubble pressure and temperature.

15. The apparatus of claim 14 where the rigid structural container is pressurized to further increase the collapsing gas bubble internal pressure.

16. The apparatus of claim 14 where the rigid structural container is made of steel, iron, aluminum coated with Al₂O₃ or glass, filled with mercury, and has a gas introduction syringe at the bottom of the container where the 0.1 to 10 mm diameter bubble of a defined gas is introduced, allowed to float to a suspended position and the cylinder is dropped vertically onto a solid base thereof to generate a hydraulic shockwave impacting the suspended bubble.

17. The apparatus of claim 14 where the rigid structural container is provided with a top including a tight fitting piston, filled with mercury, provided with a gas introduction syringe at the bottom, wherein a bubble of a defined gas is introduced, allowed to float to a suspended position and impacted with the piston mechanically to generate a hydraulic shockwave which impacts the suspended bubble.

18. The apparatus of claim 14 where the rigid structural container is provided with tight fitting pistons on two or more opposing sides, the container is filled with mercury, and has a gas introduction syringe introducing a bubble of a defined gas, allowing the bubble to float to a suspended position and impacting the pistons simultaneously so as to mechanically to generate a hydraulic shockwave impacting the suspended bubble.

19. The apparatus of claim 14 where the rigid structural container is provided with internal pistons produced from a strong neodymium type permanent magnet that are pulsed by an external opposing magnetic force to generate the shockwave and ameliorate sealing issues.

20. The apparatus of claim 14 wherein the rigid structural container is made from a non-magnetic material, filled with mercury and the shockwave is produced by a magnetic pulse acting on the mercury.
